(19) United States
(12) Patent Application Publication
(10) Pub. No.: US 2005/0274271 A1
(43) Pub. Date: Dec. 15, 2005

(54) Method of preventing dye transfer back on to tension rollers

(75) Inventors: Thomas M. Stephany, Churchville, NY (US); Kenneth D. Corby, Rochester, NY (US); David L. Patton, Webster, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/865,098

(22) Filed: Jun. 10, 2004

(51) Int. Cl. B41F 35/00

(52) U.S. Cl. 101/424.1

(57) ABSTRACT

A method of reducing or eliminating dye build-up on tension rollers in a thermal printing system is presented. The thermal printing system comprises a station capable of depositing black dye on a media. The method comprises the steps of depositing the black dye on the media and processing the black dye prior to the black dye reaching the tension roller. Processing the black dye includes techniques, such as cooling the black dye, re-routing the black dye, and drying the black dye before the black dye comes in contact with the tension rollers.

### FIELD OF THE INVENTION

The invention relates generally to the field of printers and in particular to thermal printers. More specifically, the invention relates to a method and apparatus for reducing and/or eliminating dye build-up on tension rollers in a thermal printer.

### BACKGROUND OF THE INVENTION

A conventional thermal printer includes a number of stations for delivering color to a media using a dye or other types of delivery mechanism. During operation, a specific location on a media, such as paper, is moved from one station to another and each station is capable of depositing dye on the media at the specific location. A microprocessor controls the amount of dye deposited from each station and as such, a variety of colors may be realized on the media.

In a thermal printer, each station includes a thermal head that uses heat to transfer a dye from a donor ribbon onto the media. Transferring the dye from the donor ribbon onto the media registers an impression on the media. When one or more stations deposit different dyes on the media at the same location, a variety of colors may be realized on the media. After each station has deposited the dye on the media, a final station deposits a clear coat on the media to safeguard the dye deposited on the media. In addition to protecting the dye deposited on the media, the clear coat often has a reflective quality that enhances the impression registered on the media producing enhanced colors.

As conventional thermal printers advance, a variety of techniques are developing to produce enhanced colors. As a result of size limitations, cost limitations, etc., a number of these techniques require the removal of the final station that applies the clear coat. Without the clear coat, any excess dye deposited on the media may build-up on other structures and/or devices in the thermal printer. Dye may build-up (i.e., dye build-up) on devices or structures that come in contact with the media after the dye has been deposited on the media. For example, tension rollers engage the media and may come in contact with the dye if there is no clear coat to separate the tension rollers from the dye. As a result, dye build-up may develop on the tension rollers. Once the dye build-up on devices, such as the tension rollers become too great, the devices may re-deposit the dye build-up back onto the media. Re-depositing the dye build-up back onto the media may ultimately destroy the initial impression registered on the media.

Thus, there is a need for a method and apparatus for producing enhanced colors in thermal printing systems. There is a need for a method and apparatus for reducing and/or illuminating dye build-up in thermal printing systems.

### SUMMARY OF THE INVENTION

The present invention is directed to overcoming one or more of the problems set forth above. Briefly summarized, according to one aspect of the present invention, a method is presented for reducing dye build-up on tension rollers operating in a thermal printing system. The thermal printing system comprises a station capable of depositing black dye on a media. The method comprises the steps of depositing the black dye on the media and processing the black dye prior to the black dye reaching the tension rollers. It should be appreciated that processing the black dye includes a number of techniques designed to reduce and/or eliminate the build-up of the black dye on the tension rollers.

In one embodiment, the step of processing the black dye prior to the black dye making contact with the tension rollers comprises the step of rerouting the black dye prior to the black dye engaging the tension rollers. For example, a donor ribbon used to transfer the black dye to the media is routed around a tension roller to avoid dye build-up on the tension roller.

In a second embodiment, the step of processing the black dye prior to the black dye making contact with the tension rollers includes the step of drying the black dye prior to the black dye engaging the tension rollers. For example, a blotting roller is positioned between a station capable of depositing black dye and a tension roller to absorb any excess dye on the media.

In a third embodiment, the step of processing the black dye prior to the black dye making contact with the tension rollers includes the step of cooling the black dye prior to the black dye engaging the tension rollers. For example, an airflow mechanism is positioned to direct air toward a media after dye has been deposited on the media but prior to the dye reaching the tension rollers. In alternative embodiments, cooling may be accomplished using a Peltier device to generate a cold region and dry the black dye using chilled water to generate a cold region and dry the black dye, etc.

Lastly, in another embodiment, processing the black dye prior to the black dye making contact with the tension rollers includes the step of providing enough spacing between the station that deposits the black dye and the tension rollers so that the black dye will dry prior to reaching the tension rollers.

Briefly summarized according to a second aspect of the present invention, a method and apparatus for enhancing color in a thermal printing system is presented. In one embodiment, a station capable of depositing black dye on a media is implemented in a thermal printer system to produce enhanced colors.

The above and other objects of the present invention will become more apparent when taken in conjunction with the following description and drawings wherein identical reference numerals have been used, where possible, to designate identical elements that are common to the figures. These and other aspects, objects, features, and advantages of the present invention will be more clearly understood and appreciated from a review of the following detailed description of the preferred embodiments and appended claims, and by reference to the accompanying drawings.

The present invention details advantageous techniques for enhancing the color produced by a thermal printer. In addition, the present invention includes advantageous techniques for reducing dye build-up on tension rollers.

### BRIEF DESCRIPTION OF THE DRAWINGS

FIG. 1 is an embodiment of a thermal printing system including a station capable of depositing black dye on a media;

FIG. 2 is an embodiment of a thermal printing system including a mechanism for rerouting a donor ribbon;

FIG. 3 is an embodiment of a thermal printing system including a mechanism for drying excess dye;

FIG. 4 is an embodiment of a thermal printing system including a mechanism for cooling excess dye; and

FIG. 5 is an embodiment of a thermal printing system including appropriate spacing to dry excess dye.

### DETAILED DESCRIPTION OF THE INVENTION

In the following description, the present invention will be described in the preferred embodiment as a software program. Those skilled in the art will readily recognize that the equivalent of such software may also be constructed in hardware.

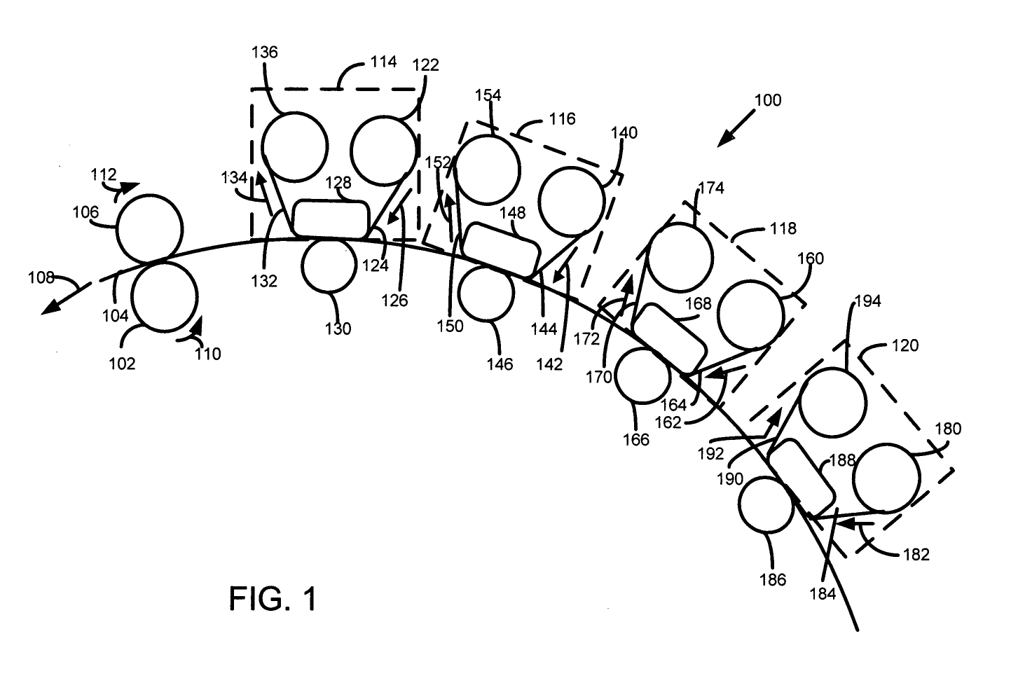

FIG. 1 is an embodiment of a thermal printing system including a station capable of depositing black dye on a media. Referring to FIG. 1, a thermal printing system 100 is shown. A lower tension roller 102 is shown positioned relative to an upper tension roller 106 so that the lower tension roller 102 in combination with the upper tension roller 106 apply a compressive force to a media 104. In one embodiment, tension roller 102 moves in a direction indicated by directional arrow 110 and tension roller 102 moves in a direction indicated by directional arrow 110. The combination of lower tension roller 102 and upper tension roller 106 pull the media 104 through the thermal printing system 100.

A station 114, a station 116, a station 118, and a station 120 are positioned in the thermal printing system 100 to deposit a dye on the media 104. It should be appreciated that a station may include any system or mechanism used to deposit dye on the media 104. Although stations employing thermal technology are discussed and described, the scope of the present invention is beyond thermal technology. It should also be appreciated that the term “dye” and/or the phrase “depositing a dye” is used to describe the scenario where ink, wax, or some other transfer material or mechanism is used by the station (i.e., 114, 116, 118, 120) to deposit a color on the media 104.

Each station (i.e., 114, 116, 118, 120) is positioned relative to a support roller (i.e., 130, 146, 166, 186) to move the media 104 through the thermal printing system 100 and deposit dye on the media 104. For example, support roller 130 is positioned relative to station 114 to process the media 104. Support roller 146 is positioned relative to the station 116 to process the media 104. Support roller 166 is positioned relative to station 118 to process the media 104. Lastly, support roller 186 is positioned relative to station 120 to process the media 104.

In one embodiment, the station 114 includes a donor ribbon supply 122 and a donor ribbon take-up 136. A thermal head 128 is positioned relative to the donor ribbon supply 122 and the donor ribbon take-up 136 to receive donor ribbon 124 and utilize donor ribbon 124 to deposit dye on the media 104. On an opposite side of thermal head 128, donor ribbon 124 is collected by donor ribbon take-up 136. For the purposes of discussion, the donor ribbon collected by donor ribbon take-up 136 will be referred to as “take-up ribbon.” For example, items 132, 150, 170, 190, and other items collected by a donor ribbon take-up will be referred to as a take-up ribbon. In addition, a support roller 130 is shown positioned on an opposite side of the media 104 from the thermal head 128.

During operation of the thermal printing system 100, the media 104 is pulled through the thermal printing system 100 by the tension rollers 102 and 106. During operation of the station 114, the media 104 is positioned between the thermal head 128 and the support roller 130. Donor ribbon 124 is supplied by the donor ribbon supply 122 and moves toward the thermal head 128 as shown by directional arrow 126. The donor ribbon 124 is positioned between the thermal head 128 and the media 104, where the thermal head 128 utilizes the donor ribbon 124 to deposit a dye on the media 104. Take-up ribbon 132 moves in a direction denoted by directional arrow 134 and is collected by donor ribbon take-up 136.

During operation, the donor ribbon 124 is positioned between the thermal head 128 and the media 104. The thermal head 128 is heated and deposits the dye on the media 104. In one embodiment, the station 114 is capable of depositing a black dye on the media 104. For example, donor ribbon 124 is implemented as a black donor ribbon 124. As such, when the thermal head 128 is heated, black dye is deposited on the media 104.

A station 116 includes a donor ribbon supply 140 and a donor ribbon take-up 154. A thermal head 148 is positioned relative to the donor ribbon supply 140 and the donor ribbon take-up 154 to receive donor ribbon 144 and utilize donor ribbon 144. Take-up ribbon 150 is then collected at donor ribbon take-up 154. A support roller 146 is positioned on an opposite side of the media 104 from the thermal head 148. Further, the donor ribbon 144 is positioned between the thermal head 148 and the media 104. In one embodiment, the station 116 is capable of depositing cyan colored dye on the media 104.

During operation of station 116, the media 104 is positioned between the thermal head 148 and the support roller 146. Donor ribbon 144 is supplied by the donor ribbon supply 140 and moves toward the thermal head 148 as shown by directional arrow 142. The donor ribbon 144 is positioned between the thermal head 148 and the media 104, where the thermal head 148 utilizes the donor ribbon 144 to deposit a dye stored on the donor ribbon 144 on the media 104. Take-up ribbon 150 moves in a direction denoted by directional arrow 152 and is collected by donor ribbon take-up 154.

During operation, the donor ribbon 144 is positioned between the thermal head 148 and the media 104. The thermal head 148 is heated and deposits a dye on the media 104. In one embodiment, the station 116 is capable of depositing a cyan colored dye on the media 104. For example, donor ribbon 144 is implemented as a cyan donor ribbon 144. As such, when the thermal head 148 is heated, the color cyan is deposited on the media 104.

A station 118 includes a donor ribbon supply 160 and a donor ribbon take-up 174. A thermal head 168 is positioned relative to the donor ribbon supply 160 and the donor ribbon take-up 174 to receive donor ribbon 164 and utilize donor ribbon 164. Take-up ribbon 170 is then collected at donor ribbon take-up 174. A support roller 166 is positioned on an opposite side of the media 104 from the thermal head 168.

During operation of the station 118, the media 104 is positioned between the thermal head 168 and the support roller 166. Donor ribbon 164 is supplied by the donor ribbon supply 160 and moves toward the thermal head 168 as shown by directional arrow 162. The donor ribbon 164 is positioned between the thermal head 168 and the media 104, where the thermal head 168 utilizes the donor ribbon 164 to deposit a dye on the media 104. Take-up ribbon 170 moves in a direction denoted by directional arrow 172 for collection by the donor ribbon take-up 174.

During operation, the donor ribbon 164 is positioned between the thermal head 168 and the media 104. The thermal head 168 is heated and deposits dye on the media 104. In one embodiment, the station 118 is capable of depositing a magenta dye on the media 104. For example, donor ribbon 164 is implemented as a magenta donor ribbon 164. As such, when the thermal head 168 is heated, a magenta dye is deposited on the media 104.

A station 120 includes a donor ribbon supply 180 and a donor ribbon take-up 194. A thermal head 188 is positioned relative to the donor ribbon supply 180 and the donor ribbon take-up 194 to receive donor ribbon 184 and utilize donor ribbon 184. Take-up ribbon 190 is then collected at donor ribbon take-up 194. A support roller 186 is positioned on an opposite side of the media 104 from the thermal head 188.

During operation of the station 120, the media 104 is positioned between the thermal head 188 and the support roller 186. Donor ribbon 184 is supplied by the donor ribbon supply 180 and moves toward the thermal head 188 as shown by directional arrow 182. The donor ribbon 184 passes between the thermal head 188 and the media 104, where the thermal head 188 utilizes the donor ribbon 184 to deposit a dye stored on the donor ribbon 184 on the media 104. A take-up ribbon 190 moves in a direction denoted by directional arrow 192 for collection by the donor ribbon take-up 194.

During operation of the station 120, donor ribbon 184 is positioned between the thermal head 188 and the media 104. The thermal head 188 is heated and deposits dye on the media 104. In one embodiment, the station 120 is capable of depositing a yellow dye on the media 104. For example, donor ribbon 184 is implemented as a yellow donor ribbon 184. As such, when the thermal head 188 is heated, a yellow dye is deposited on the media 104.

During operation of the thermal printing system 100, the media 104 is positioned between the tension rollers 102 and 106, thermal head 128 and support roller 130, thermal head 148 and support roller 146, thermal head 168 and support roller 166, and thermal head 188 and support roller 186. As tension roller 102 rotates as shown by directional arrow 110 and tension roller 106 rotates as shown by directional arrow 112, the media 104 is pulled through the thermal printing system 100 in a direction shown by arrow 108. As the media is drawn through the thermal printing system 100, each station 114, 116, 118, and 120 is capable of depositing dye on the media 104 at the same location or at a different location. For example, in one embodiment of the thermal printing system 100, station 114 is capable of depositing black dye on media 104, station 116 is capable of depositing cyan dye on media 104, station 118 is capable of depositing magenta dye on media 118, and station 120 is capable of depositing yellow dye on media 104. Each station (i.e., 114, 116, 118, 120) deposits dye on the media 104 at a predefined location and in the quantities necessary to realize a final color or picture on the media 104. For example, each station (i.e., 114, 116, 118, 120) may deposit predefined amount of dye on the same location on the media 104 to produce the color red, green purple, etc. Further, in accordance with one embodiment of the present invention, the final station, station 114, is implemented with a black dye to deliver black color. As such, in accordance with one objective of the present invention, enhanced colors are produced by the thermal printing system 100.

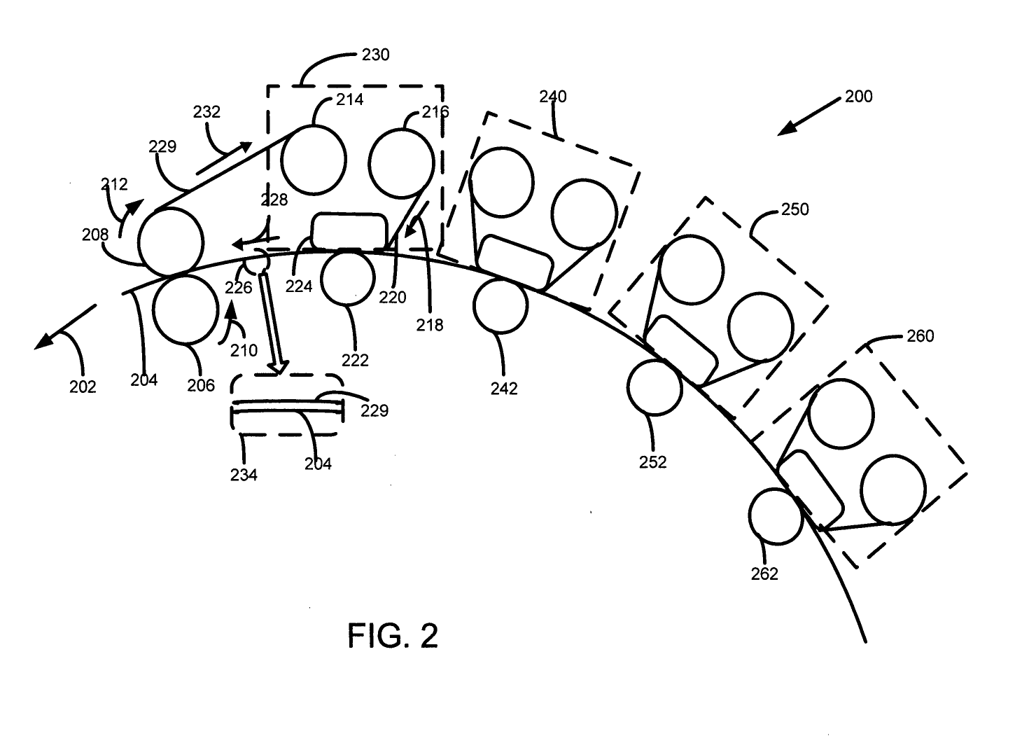

FIG. 2 is an embodiment of a thermal printing system including a mechanism for rerouting a donor ribbon. FIG. 2 displays one embodiment in which a take-up ribbon is routed around an upper tension roller prior to collection by the donor ribbon take-up. As such, in accordance with the teachings of the present invention, dye build-up on the tension rollers is reduced or eliminated.

Referring to FIG. 2, a thermal printing system 200 is shown. The thermal printing system 200 includes a lower tension roller 206 positioned below media 204 and an upper tension roller 208 positioned above the media 204. In one embodiment, the lower tension roller 206 and the upper tension roller 208 are positioned to apply compressive force to the media 204 and move the media 204 through the thermal printing system 200.

A plurality of stations 230, 240 250, and 260 are shown. Support rollers 222, 242, 252, and 262 are positioned on an opposite side of the media 204 from the stations 230, 240, 250, and 260.

In one embodiment, the station 230 includes a donor ribbon supply 216. Thermal head 224 is positioned so that donor ribbon 220 may be routed from the donor ribbon supply 216 to the thermal head 224. The upper tension roller 208 is positioned so that the take-up ribbon 229 may be conveyed along with the media 204 to the upper tension roller 208 as shown by directional arrow 228 and directional arrow 218. A magnified view 234 of an area denoted as 226 displays take-up ribbon 229 and the media 204. The upper tension roller 208 is positioned relative to the thermal head 224 and to the donor ribbon take-up 214 so that the take-up ribbon 229 may be routed around the upper tension roller 208 and then collected by the donor ribbon take-up 214. The donor ribbon take-up 214 is positioned to collect the take-up ribbon 229 after the take-up ribbon 229 is routed around the upper tension roller 208. In accordance with the teachings of the present invention, routing the take-up ribbon 229 around the upper tension roller 208 reduces or eliminates the build-up of dye material on the upper tension roller 208.

During operation of the thermal printing system 200, the media 204 is positioned between the station 260 and the support roller 262, the station 250 and the support roller 252, the station 240 and the support roller 242, the station 230 and the support roller 222, and the upper tension roller 208 and the lower tension roller 206. In one embodiment, the lower tension roller 206 rotates as shown by directional arrow 210 and the upper tension roller 208 rotates in a direction as shown by directional arrow 212. As the tension rollers (206, 208) rotate, the media 204 is pulled through the thermal printing system 200 in a direction shown by arrow 202. As the media is pulled through the thermal printing system 200, station 260 may deposit yellow dye on the media 204, station 250 may deposit magenta dye media on the media 204, station 240 may deposit cyan dye on the media 204, and station 230 may deposit black dye on the media 204.

In one embodiment, donor ribbon 220 is supplied by donor ribbon supply 216 and positioned between thermal head 224 and support roller 222. Specifically, donor ribbon 220 is positioned between thermal head 224 and media 204. Station 230 may utilize donor ribbon 220 to deposit dye on media 204. In one embodiment, take-up ribbon 229 is then routed in the same direction as the media 204 as shown by directional arrow 228. The take-up ribbon 229 is then routed around upper tension roller 208. Subsequent to routing the take-up ribbon 229 around the upper tension roller 208, the take-up ribbon 229 is routed to the donor ribbon take-up 214 as shown by directional arrow 232. In accordance with the teachings of the present invention, since the take-up ribbon 229 is positioned around the upper tension roller 208, the dye build-up on the upper tension roller 208 is reduced or eliminated.

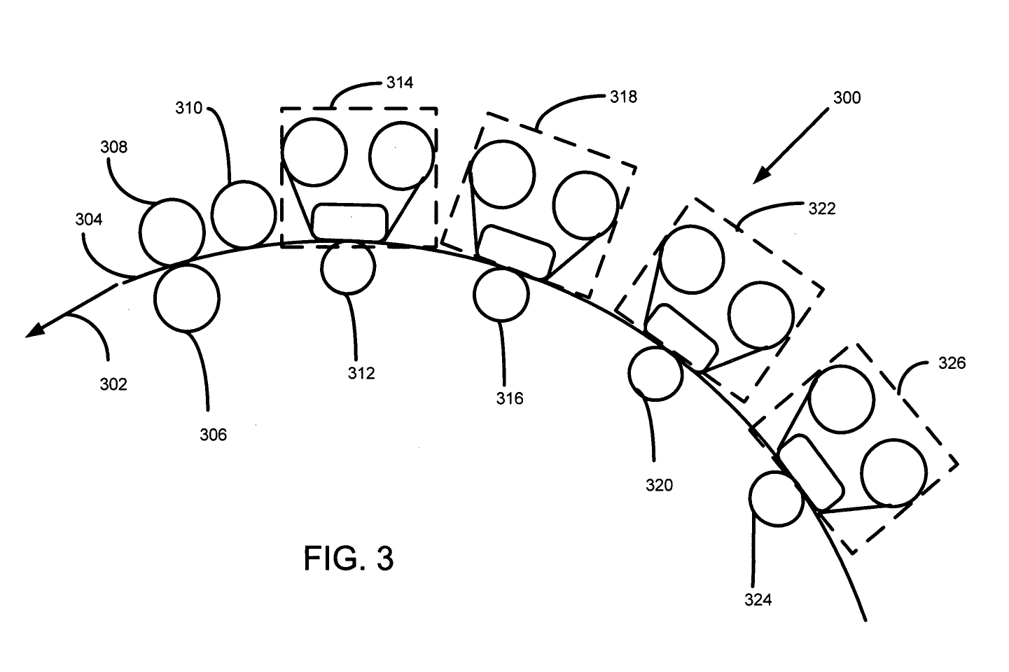

FIG. 3 is an embodiment of a thermal printing system including a mechanism for drying excess dye. Referring to FIG. 3, a thermal printing system 300 including a blotter roller 310 is shown. The thermal printing system 300 includes a lower tension roller 306 positioned below media 304 and an upper tension roller 308 positioned above the media 304. In one embodiment, the lower tension roller 306 and the upper tension roller 308 are positioned to apply compressive force to the media 304 and rotate to pull media 304 through the thermal printing system 300. A plurality of stations 314, 318, 322, and 326 are shown. Each station (i.e., 314, 318, 322, 326) is capable of depositing a dye on the media 304. Support rollers 312, 316, 320, and 324 are disposed on an opposite side of the media 304 from the stations 314, 318, 322 and 326, respectively. In one embodiment, blotting roller 310 is positioned between the upper tension roller 308 and station 314. It should be appreciated that blotting roller 310 may include any absorption mechanism for removing excess dye deposited by any one of the stations 314, 318, 322, 326. Additionally, it may include a cleaning means through the application of a cleaning agent, such as alcohol.

During operation of the thermal printing system 300, the media 304 is positioned between the station 326 and the support roller 324, the station 322 and the support roller 320, the station 318 and the support roller 316, the station 314 and the support roller 312, and the upper tension roller 308 and the lower tension roller 306. As the tension rollers (306, 308) rotate, the media 304 is pulled through the thermal printing system 300 in a direction shown by arrow 302. As the media 304 is moved through the thermal printing system 300, station 326 may deposit yellow dye on the media 304, station 322 may deposit magenta dye on the media 304, station 318 may deposit cyan dye on the media 304, and station 314 may deposit black dye on the media 304. It should be understood by those skilled in the art that these dyes may be deposited in other desired sequences of colors due to individual engineering needs.

In one embodiment, after station 314, the blotting roller 310 makes contact or engages the media 304 to absorb or likewise remove any excess dye from the media. For example, after the media 304 moves beyond the last station (i.e., station 314) in the thermal printing system 300, placing the blotting roller 310 in contact with the media 304 would ensure that any excess dye deposited on the media 304 from any station (i.e., 326, 322, 318, 314) is reduced and/or removed.

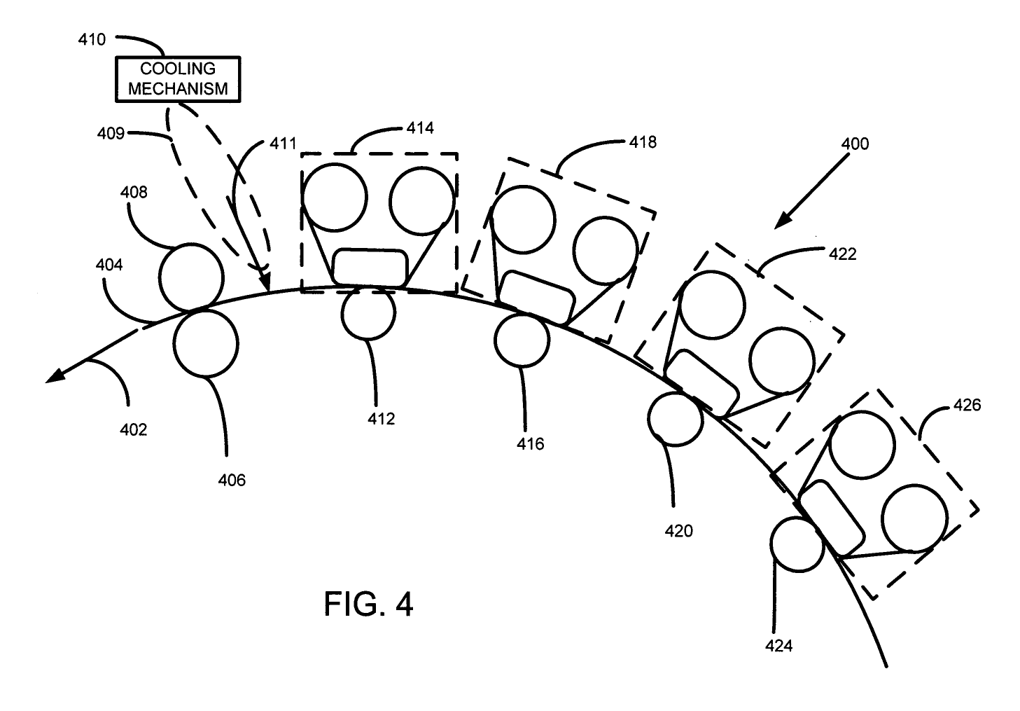

FIG. 4 is an embodiment of a thermal printing system including a mechanism for cooling excess dye. Referring to FIG. 4, a thermal printing system 400 including a cooling mechanism is shown. The thermal printing system 400 includes a lower tension roller 406 positioned below media 404 and an upper tension roller 408 positioned above the media 404. In one embodiment, the lower tension roller 406 and the upper tension roller 408 are positioned to apply compressive force to the media 404. A plurality of stations 414, 418, 422, and 426 are shown. Supports rollers 412, 416, 420, and 424 are disposed on an opposite side of the media 404 from the stations 414, 418, 422 and 426.

A cooling mechanism 410 is implemented to cool excess dye. In one embodiment, the cooling mechanism 410 generates a cold region 409 in the direction shown by directional arrow 411 to dry excess dye. In accordance with the teachings of the present invention, the cooling mechanism 410 represents any mechanism that may be used to generate a cold region 409. For example, the cooling mechanism 410 may be implemented with a fan, a Peltier device, a chilled water generator, etc.

In one embodiment, the cooling mechanism 410 is implemented with an airflow mechanism, such as a fan. In one embodiment, the airflow mechanism (i.e., the cooling mechanism 410) is positioned between the upper tension roller 408 and the station 414 closest to the upper tension roller 408. However, it should be appreciated that the airflow mechanism (i.e., the cooling mechanism 410) may be positioned in any location suitable for directing air toward the media 404 after the media 404 has moved beyond station 414.

During operation of the thermal printing system 400, the media 404 is positioned between the station 426 and the support roller 424, the station 422 and the support roller 420, the station 418 and the support roller 416, the station 414 and the support roller 412, and the upper tension roller 408 and the lower tension roller 406. As the tension rollers (406, 408) rotate, the media 404 is pulled through the thermal printing system 400 in a direction shown by arrow 402. As the media is moved through the thermal printing system 400, station 426 may deposit dye on the media 404, station 422 may deposit dye on the media 404, station 418 may deposit dye on the media 404, and station 414 may deposit dye on the media 404.

In one embodiment, after the last station before the upper tension roller 408 (i.e., 414) delivers a dye to the media 404, the cooling mechanism 410 generates a cold region 409 as shown by directional arrow 411 in the direction of the media 404. Excess dye on the media 404 is air-cooled by the cold region 409 generated by the cooling mechanism 410 prior to the excess dye reaching the upper tension roller 408. As such, in accordance with the teachings of the present invention, dye build-up on the upper tension roller 408 is reduced or eliminated.

As mentioned previously, a variety of alternative mechanisms may be used to implement the cooling mechanism 410 and generate the cold region 409. For example, the cooling mechanism 410 may be implemented with a Peltier device (i.e., cooling mechanism) or chilled water generator. In one embodiment, a Peltier device (i.e., cooling mechanism 410) or an appendage attached to a Peltier device (i.e., cooling mechanism 410) may generate the cold region 409. The cold region 409 or an appendage generating the cold region 409 may be placed in contact with the dye and cool and/or dry the excess dye. In an alternate embodiment, the Peltier device (i.e., cooling mechanism 410) may generate the cold region 409 in proximity to the dye on media 404 and as a result, cool and/or dry the excess dye.

A chilled water generator (i.e., cooling mechanism 410) may be used to generate the cold region 409 and cool and/or dry excess dye. For example a chilled water generator (i.e., cooling mechanism 410) may produce chilled water that generates the cold region 409 and is then used to cool or dry the excess dye. In the alternative, the chilled water generator (i.e., cooling mechanism 410) may connect to an appendage that generates the cold region 409 and/or is placed in contact or within proximity of the dye to cool and/or dry the dye. It should be appreciated that the cooling mechanism may be positioned in a variety of locations in the thermal printing system 410. For example, a Peltier device may be positioned at an alternate location in the thermal printing system 400 and then an appendage may be used to generate a cold region 409, in the area of the dye.

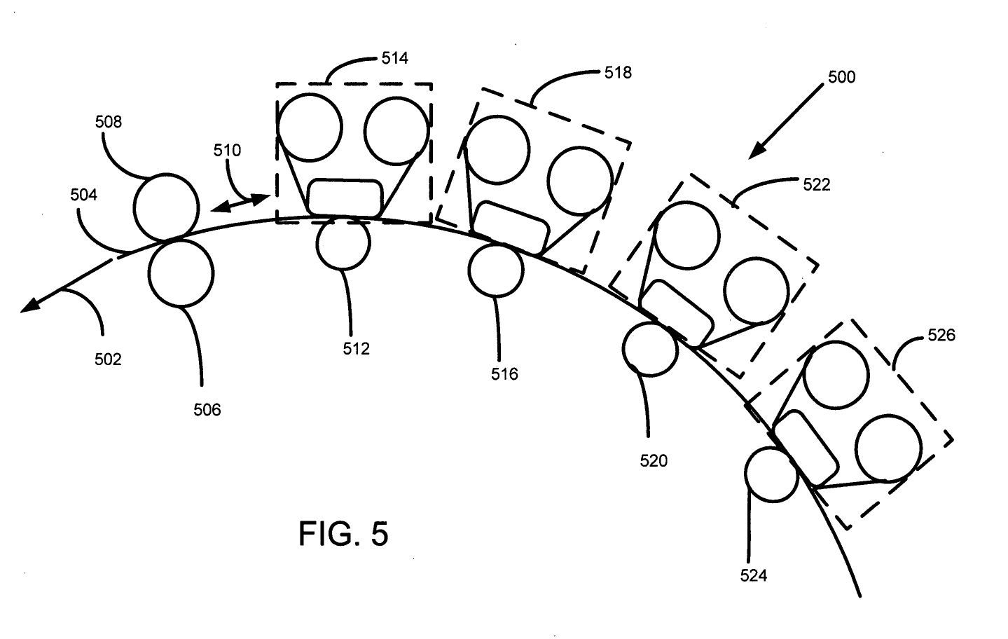

FIG. 5 is an embodiment of a thermal printing system including appropriate spacing to dry excess dye. Referring to FIG. 5, a thermal printing system 500 including spacing between the tension rollers and the stations is shown. The thermal printing system 500 includes a lower tension roller 506 positioned below media 504 and an upper tension roller 508 positioned above the media 504. In one embodiment, the lower tension roller 506 and the upper tension roller 508 are positioned to apply compressive force to the media 504. A plurality of stations 514, 518, 522, and 526 are shown. Supports rollers 512, 516, 520, and 524 are disposed on an opposite side of the media 504 from the stations 514, 518, 522 and 526. In one embodiment, spacing is shown between the upper tension roller 508 and the station 514 closest to the upper tension roller 508. In one embodiment, the spacing 510 is defined such that when dye is deposited on the media 504 by station 514 enough spacing 510 is provided between station 514 and the upper tension roller 508 so that the dye deposited by station 514 dries before the dye reaches the upper tension roller 508. As such, in accordance with the teachings of the present invention, the dye build-up on the upper tension roller 508 is reduced or eliminated.

During operation of the thermal printing system 500, the media 504 is positioned between the station 526 and the support roller 524, the station 522 and the support roller 520, the station 518 and the support roller 516, the station 514 and the support roller 512, and the upper tension roller 508 and the lower tension roller 506. As the tension rollers (506, 508) rotate, the media 504 is moved through the thermal printing system 500 in a direction shown by arrow 502. As the media 504 is pulled through the thermal printing system 500, station 526 may deposit dye on the media 504, station 522 may deposit dye on the media 504, station 518 may deposit dye on the media 504, and/or station 514 may deposit dye on the media 504.

In one embodiment, after the last station (i.e., 514) deposits a dye to the media 504, the spacing 510 is defined so that any excess dye on the media 504 dries prior reaching the upper tension roller 508. As such, dye build-up on the upper tension roller 508 will be eliminated or reduced. It should be appreciated that the spacing 510 may depend on a number of variables. For example, the spacing 510 may depend on the speed that the media 504 moves through the thermal printing system 500, the temperature required to dry excess dye, the amount of excess dye deposited on the media 504, the ability of the media 504 to absorb the excess dye, etc.

The invention has been described with reference to a preferred embodiment. However, it will be appreciated that variations and modifications can be effected by a person of ordinary skill in the art without departing from the scope of the invention.

### Parts List

100 thermal printing system
102 lower tension roller
104 media
106 upper tension roller
108 directional arrow
110 directional arrow
112 directional arrow
114 station
116 station
118 station
120 station
122 donor ribbon supply
124 donor ribbon
126 directional arrow
128 thermal head
130 support roller
132 take-up ribbon
134 directional arrow
136 donor ribbon take-up
140 donor ribbon supply
142 directional arrow
144 donor ribbon
146 support roller
148 thermal head
150 take-up ribbon
152 directional arrow
154 donor ribbon take-up
160 donor ribbon supply
162 directional arrow
164 donor ribbon

### Parts List (Continued)

166 support roller
168 thermal head
170 take-up ribbon
172 directional arrow
174 donor ribbon take-up
180 donor ribbon supply
182 directional arrow
184 donor ribbon
186 support roller
188 thermal head
190 take-up ribbon
192 directional arrow
194 donor ribbon take-up
200 thermal printing system
202 directional arrow
204 media
206 lower tension roller
208 upper tension roller
210 directional arrow
212 directional arrow
214 donor ribbon take-up
216 donor ribbon supply
218 directional arrow
220 donor ribbon
222 support roller
224 thermal head
226 denoted area
228 directional arrow
229 take-up ribbon
230 station
232 directional arrow

### Parts List (Continued)

234 magnified view
240 station
242 support roller
250 station
252 support roller
260 station
262 support roller
300 thermal printing system
302 directional arrow
304 media
306 lower tension roller
308 upper tension roller
310 blotting roller
312 support roller
314 station
316 support roller
318 station
320 support roller
322 station
324 support roller
326 station
400 thermal printing system
402 directional arrow
404 media
406 lower tension roller
408 upper tension roller
409 cold region
410 cooling mechanism
411 directional arrow
412 support roller
414 station

### Parts List (Continued)

416 support roller
418 station
420 support roller
422 station
424 support roller
426 station
500 thermal printing system
502 directional arrow
504 media
506 lower tension roller
508 upper tension roller
510 spacing
512 support roller
514 station
516 support roller
518 station
520 support roller
522 station
524 support roller
526 station

1. A method of reducing dye build-up on a tension roller positioned in a thermal printing system, the thermal printing system comprising a station capable of depositing dye on a media, the method comprising the steps of:
depositing the dye on the media; and
processing the dye prior to the dye reaching the tension roller.

2. A method of reducing dye build-up on a tension roller positioned in a thermal printing system as set forth in claim 1, wherein the step of processing the dye prior to the dye reaching the tension roller comprises the step of rerouting the dye prior to the dye reaching the tension roller.

3. A method of reducing dye build-up on a tension roller positioned in a thermal printing system as set forth in claim 2, wherein the step of rerouting the dye prior to the dye reaching the tension roller further comprises the step of rerouting the dye around the tension roller.

4. A method of reducing dye build-up on a tension roller positioned in a thermal printing system as set forth in claim 1, wherein the step of processing the dye prior to the dye reaching the tension roller further comprises the step of drying the dye prior to the dye reaching the tension roller.

5. A method of reducing dye build-up on a tension roller positioned in a thermal printing system as set forth in claim 4, wherein the step of drying the dye prior to the dye reaching the tension roller further comprises the step of drying the dye with a blotting roller prior to the dye reaching the tension roller.

6. A method of reducing dye build-up on a tension roller positioned in a thermal printing system as set forth in claim 4, wherein the step of drying the dye prior to the dye reaching the tension roller further comprises the step of spacing the station from the tension roller so that the dye dries prior to reaching the tension roller.

7. A method of reducing dye build-up on a tension roller positioned in a thermal printing system as set forth in claim 1, wherein the step of processing the dye prior to the dye reaching the tension roller further comprises the step of cooling the dye prior to the dye reaching the tension roller.

8. A method of reducing dye build-up on a tension roller positioned in a thermal printing system as set forth in claim 7, wherein the step of cooling the dye prior to the dye reaching the tension roller is performed by directing air over the dye prior to the dye reaching the tension roller.

9. A method of reducing dye build-up on a tension roller positioned in a thermal printing system as set forth in claim 7, wherein the step of cooling the dye prior to the dye reaching the tension roller is performed using a Peltier device.

10. A method of reducing dye build-up on a tension roller positioned in a thermal printing system as set forth in claim 7, wherein the step of cooling the dye prior to the dye reaching the tension roller is performed using chilled water generator.

11. A method of reducing dye build-up on a tension roller positioned in a thermal printing system as set forth in claim 7, wherein the step of cooling the dye prior to the dye reaching the tension roller is performed by generating a cold region in contact with the dye prior to the dye reaching the tension roller.

12. A method of reducing dye build-up on a tension roller positioned in a thermal printing system as set forth in claim 7, wherein the step of cooling the dye prior to the dye reaching the tension roller is performed by generating a cold region in proximity to the dye prior to the dye reaching the tension roller.

13. A thermal printing system comprising:
a means for depositing black dye on a media; and
a means for reducing the black dye on the media prior to the black dye contacting a tension roller.

14. A thermal printing system comprising:
a donor ribbon supply;
a thermal head;
a tension roller;
a donor ribbon take-up, wherein the donor ribbon supply, the thermal head, the tension roller, and the donor ribbon take-up are positioned to route a donor ribbon from the donor ribbon supply, across the thermal head, around the tension roller, and to the donor ribbon take-up.

15. A thermal printing system comprising:
a station placing dye on a media;
a tension roller pulling the media; and
a blotter roller positioned between the station and the tension roller, the blotter roller capable of removing the dye from the media.

16. A thermal printing system as set forth in claim 15, wherein the thermal printing system includes a plurality of stations.

17. A thermal printing system as set forth in claim 15, wherein the dye is black dye.

18. A thermal printing system comprising:
a station placing dye on a media;
a tension roller pulling the media through the thermal printing system; and
a cooling mechanism positioned between the station and the tension roller, the cooling mechanism cooling the dye prior to the dye making contact with the tension roller.

19. A thermal printing system as set forth in claim 18, wherein the cooling mechanism is implemented with a fan.

20. A thermal printing system as set forth in claim 18, wherein the cooling mechanism is implemented with a Peltier device.

21. A thermal printing system as set forth in claim 18, wherein the cooling mechanism is implemented with a chilled water generator.
